(19) United States
(12) Patent Application Publication
(10) Pub. No.: US 2015/0237323 A1
(43) Pub. Date: Aug. 20, 2015

(54) 3D VIDEO REPRESENTATION USING INFORMATION EMBEDDING

(71) Applicants: Lin Du, Beijing (CN); Jianping Song, Beijing (CN); Yan Xu, Beijing (CN)

(72) Inventors: Lin Du, Beijing (CN); Jianping Song, Beijing (CN); Yan Xu, Beijing (CN)

(73) Assignee: THOMLSON LICENSING

(21) Appl. No.: 14/415,903

(22) PCT Filed: Jul. 23, 2012
(86) PCT No.: PCT/CN2012/079026

§ 371 Date: Jan. 20, 2015

(51) Int. Cl. H04N 13/00; G06T 1/00

(52) U.S. Cl. CPC H04N 13/0011; G06T 1/0028; G06T 1/0085; H04N 13/0022

(57) ABSTRACT

Layered depth image (LDI) and other more complicated 3D formats contain color, depth, and/or alpha channel information for visible pixels (base layer) and occluded pixels (occluded layers) of 3D video data. The present principles form 2D+depth/2D+delta representation using the information for the visible pixels, and embed the information for the occluded pixels into the 2D+depth/2D+delta content. When embedding, the occluded pixels that are more likely to be viewed from other view angles or used in multiple viewpoint video rendering are provided with stronger protection from transmission or compression errors. In one example, watermarking based on Least Significant Bit (LSB) and Spread Spectrum Watermarking (SSW) is used to illustrate the embedding process and the corresponding extraction process.

### TECHNICAL FIELD

This invention relates to processing of video data, in particular 3D video data, and more particularly, to a method and apparatus for generating and processing 3D video data by embedding information related to occluded pixels, and a method and apparatus for generating and processing 3D video data by extracting embedded information.

### BACKGROUND

Depth maps or disparity maps are used to provide depth or disparity information for a video image. A depth map generally determines the position of the associated video data in the 3D space, and a disparity map generally refers to a set of disparity values with a geometry corresponding to the pixels in the associated video image. A depth map or disparity map is usually defined as a monochromatic video signal with gray scale values. A disparity map or depth map, together with the associated 2D image, can be used to represent and render a 3D video.

### SUMMARY

The present principles provide a method for processing data representative of a 3D video image, comprising the steps of: accessing the data representative of the 3D video image; determining information associated with occluded pixels of the 3D video image; grouping the occluded pixels into a plurality of sets; and embedding the information associated with the occluded pixels into data associated with visible pixels in response to the grouping as described below. The present principles also provide an apparatus for performing these steps.

The present principles also provide a method for processing data representative of a 3D video image, comprising the steps of: accessing the data containing information associated with visible pixels of the 3D video image, wherein occlusion layer information for a plurality of groups of occluded pixels of the 3D video image is embedded in the information associated with the visible pixels; determining a respective embedding method for each one of the plurality of groups of the occluded pixels; and extracting the occlusion layer information for the plurality of groups of the occluded pixels in response to the respective embedding methods as described below. The present principles also provide an apparatus for performing these steps.

The present principles also provide a computer readable storage medium having stored thereon instructions for processing data representative of a 3D video image, according to the methods described above.

### BRIEF DESCRIPTION OF THE DRAWINGS

FIG. 1 is a pictorial example depicting a layered depth image (LDI) having an array of pixels viewed from a single camera position.

FIG. 2 is a pictorial example depicting a capture system with two cameras.

FIGS. 3A and 3B are pictorial examples of a pair of 2D images captured by a left camera and a right camera.

FIGS. 4A and 4B are pictorial examples of a pair of depth maps associated with FIGS. 3A and 3B respectively.

FIGS. 5A, 5B, and 5C are pictorial examples of depth, color, and alpha maps of LDI occlusion layers.

FIG. 6 is a flow diagram depicting an example for representing 3D video data using a new 3D video format, in accordance with an embodiment of the present principles.

FIG. 7 is a flow diagram depicting an example for receiving 3D video data represented by a new 3D video format, in accordance with an embodiment of the present principles.

FIG. 8 is a flow diagram depicting an example for embedding occlusion layer information into 2D+depth content, in accordance with an embodiment of the present principles.

FIG. 9 is a flow diagram depicting an example for extracting occlusion layer information, in accordance with an embodiment of the present principles.

FIG. 10 is a block diagram depicting an example of an image processing system that may be used with one or more implementations.

FIG. 11 is a block diagram depicting another example of an image processing system that may be used with one or more implementations.

### DETAILED DESCRIPTION

Three-dimensional video data can be represented using various formats. 2D+delta and 2D+depth formats are mostly compatible with current 2D compression and transmission systems, and they are commonly used in image-based rendering (IBR) methods in 3D video systems.

2D+delta format is used in MPEG-2, MPEG-4, and the Multi-view Video Coding (MVC) extension of H.264/AVC. This technology utilizes a left or right eye view as the 2D version and includes the difference or disparity between an image view associated with the 2D version and a second eye view in the bit stream as user data, secondary stream, independent stream, enhancement layer, or NAL unit. The Delta data, or the difference or disparity, can be, but is not limited to, a spatial stereo disparity, temporal prediction, or motion compensation.

2D+depth format (also called 2D+Z) is a stereoscopic video format that is used for 3D displays. Each 2D image is supplemented with a grayscale depth map to which indicates depth information. Processing within a presentation apparatus uses the depth information to render 3D images.

One critical limitation of 2D+depth or 2D+delta format is associated with occlusion when rendering 3D video. With only one disparity or depth map corresponds to the 2D image, the disparity or depth information of the occluded is pixels in 2D+depth or 2D+delta format is lost and holes have to be artificially filled at the rendering stage.

A layered depth image (LDI) is a representation developed for objects with complex geometries. LDI represents an object with an array of pixels viewed from a single camera location, and it enables the rendering of virtual views of the object at a new camera position.

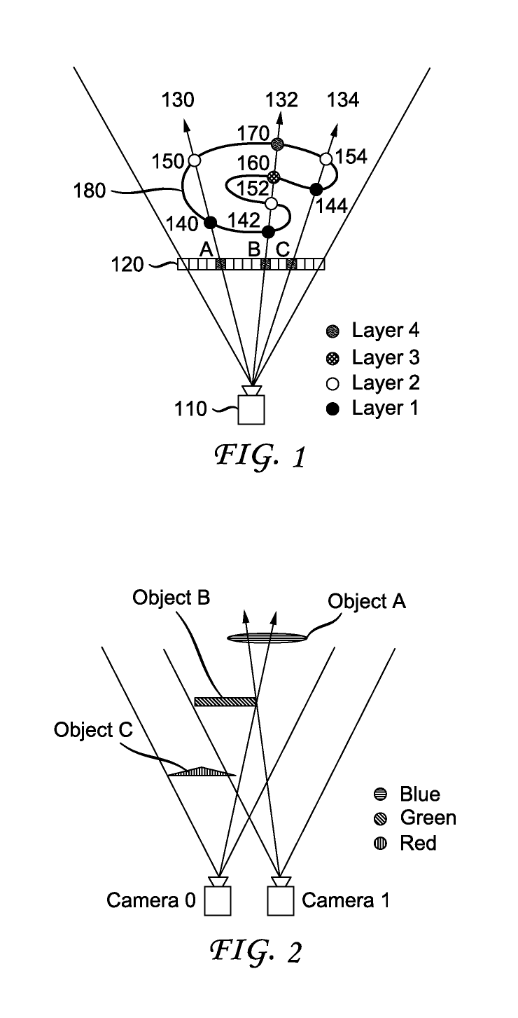

Specifically, the layered depth image consists of an array of pixels viewed from a single camera position, with possible multiple pixels along each line of sight. FIG. 1 shows an exemplary layered depth image having an array of pixels viewed from a single camera position 110. The light rays (for example, rays 130, 132, and 134) intersect the object 180 at multiple points, which are ordered from front to back. The first set of intersection points (for example, points 140, 142, and 144) of light rays constitute the first layer, the second set of intersection points (for example, points 150, 152, and 154) constitute the second layer, and so on. The number of intersection points along each light ray is denoted as the number of layers (NOL). For the example shown in FIG. 1, there are two layers for the light rays 130 and 134, and four layers for the light ray 132. The depth of the first layer corresponds to the depth used in a normal 2D+depth format. In the present application, the first layer is also defined as a base layer, and all other layers are also defined as occlusion layers.

At the original camera position 110, only pixels in the first layer are visible. Thus, in the present application, pixels in the first layer are also referred to as visible pixels, and pixels in the back layers are referred to as occluded pixels. As the viewer moves away from the original camera position, pixels in the back layers can be exposed. Unlike an ordinary image which consists of only luminance and chrominance components, LDI may contain additional information, for example, alpha channel, depth of the object, and the index into a splat table.

As described in “Layered Depth Images,” J. Shade, S. Gortler, L. He, and R. Szeliskiz, Proceeding of SIGGRAPH '98, Proceedings of the 25th annual conference on computer graphics and interactive techniques, 1998, pp. 231-242, the structure of an LDI can be summarized by the following conceptual representation:

DepthPixel=
ColorRGBA: 32 bit integer
Z: 20 bit integer
Splatlndex: 11 bit integer

LayeredDepthPixel=
NumLayers: integer
Layers[0 . . . numlayers-1]: array of DepthPixel

LayeredDepthlmage=
Camera: camera
Pixels[0 . . . xres-1,0 . . . yres-1]: array of LayeredDepthPixel

The layered depth image contains camera information plus an array of size xres by yres layered depth pixels (also referred to as LDI pixels). In addition to to image data, each layered depth pixel has an integer indicating how many valid depth pixels are contained in that pixel. The data contained in the depth pixel includes the color, the depth of the object seen at that pixel, plus an index into a table that will be used to calculate a splat size for reconstruction.

In the example shown in FIG. 1, three exemplary LayeredDepthPixel is (corresponding to LDI pixel) A, B, and C in an exemplary row 120 of an LDI image are shown. The data structure of an LDI pixel may be implemented as a linked list of DepthPixel (corresponding to depth pixel), for example, LDI pixel A in FIG. 1 may be represented as a linked list of depth pixels 140 and 150, and B as a linked list of depth pixels 142, 152, 160, and 170, and C as a linked list of depth pixels 144 and 154.

As discussed above, LDI has a more complicated data structure than 2D+depth format, and it is not compatible with current 2D video compression or transmission systems. The present principles are directed to generating and processing a new 3D video format that represents information contained in a layered depth image. Advantageously, the new 3D format is backward compatible with existing 2D+depth or 2D+delta format and can be used in existing video compression or transmission systems.

Depth is closely related to disparity. In the following, 2D+depth format is used as an example in describing representation and rendering of the new 3D format. However, the discussion can be extended to 2D+delta format and other formats.

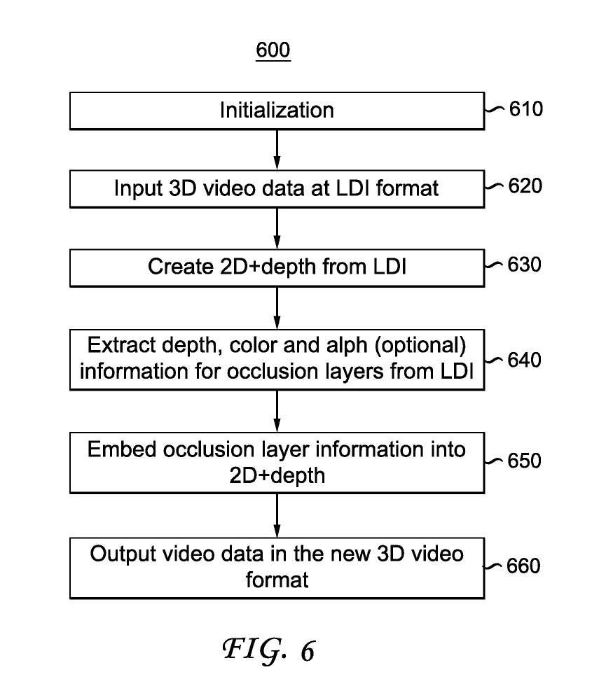

An exemplary method 600 of representing 3D video data in the new 3D format is shown in FIG. 6. Method 600 starts at initialization step 610. The initialization step may generate the LDI and determine an information embedding method. The 3D video data is input in an LDI format at step 620. At step 630, information in the LDI, for example, image pixels and depth corresponding to base layer are organized into a data structure that is compatible with 2D+depth format.

Depth, color, and alpha (optional) information are extracted for occlusion layers from the LDI at step 640, and are embedded at step 650, for example, using a digital watermarking process, into the 2D image or the depth map. The occlusion layer information may be embedded using various methods known to those skilled in the art. The specific embedding method is not critical as long as the particular method is known by the receiver to enable the receiver to parse the data appropriately.

Thus, the resulting 3D video representation contains all information from the LDI. In addition, it is backward compatible with 2D+depth format and can be used by receivers that can process a 2D+depth format but not LDI format. At step 660, the 3D video data is output in the new 3D video data representation and it is ready for further processing, for example, compression or transmission.

Method 600 may proceed in a different order from what is shown in FIG. 6. For example, step 640 may be performed before step 630.

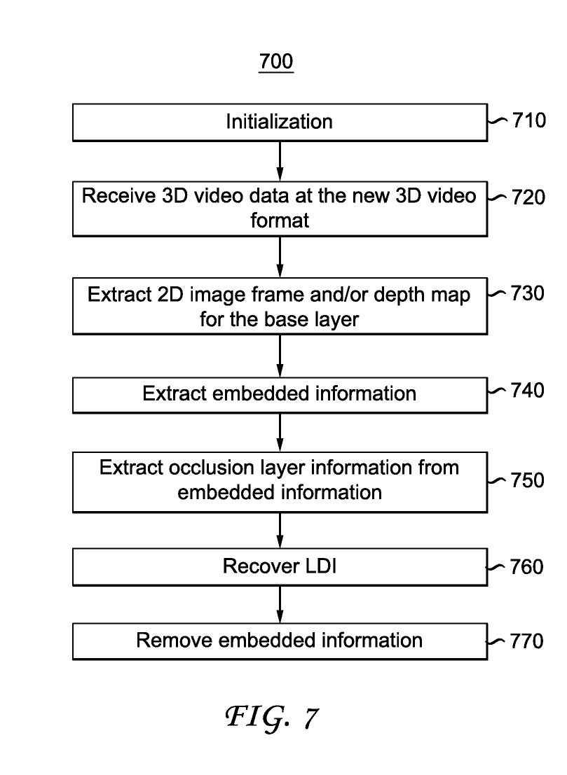

An exemplary method 700 of rendering 3D video represented by the new 3D video data representation is shown in FIG. 7. Method 700 starts at initialization step 710. The 3D video data, for example, generated by method 600, is input in the new 3D video format at step 720. The information embedding method may be obtained at the initialization step 710 or from the 3D video data at step 720. At step 730, 2D image and depth information corresponding to the base layer are extracted. At step 740, information embedded in the 2D+depth format is extracted. Subsequently, depth, color, and alpha (optional) information are extracted for occlusion layers from the embedded information at step 750. The method used for extraction corresponds to the method used for embedding, for example, at step 650. Using the base layer and occlusion layer information, the 3D video may be represented in LDI format. Thus, existing methods of rendering 3D video using LDI may be used. Optionally, the embedded information may be removed at step 770.

In the following, exemplary scenes as shown in FIGS. 1 and 2 are used to illustrate the representation and rendering of 3D video data based on the new 3D video format generated by an apparatus according to the present principles.

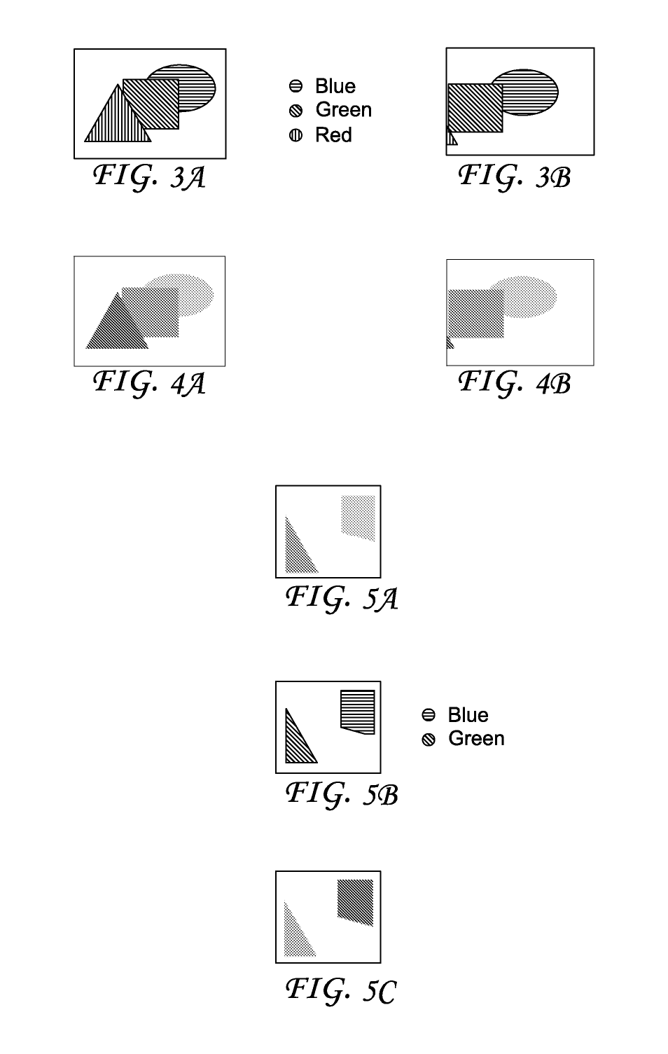

Using a capture system with cameras 0 and 1, three objects A, B, and C in FIG. 2 may be captured as 2D images by cameras 0 and 1 as shown in FIGS. 3A and 3B. The depth map that can be used in a 2D+depth format associated with FIGS. 3A and 3B are shown in FIGS. 4A and 4B, respectively, wherein white means infinity depth and black means closest depth. The depth can be obtained by depth sensors installed in cameras 0 and 1, or by a disparity map estimation algorithm from the stereo image pair. Additional information about depth, color, and alpha (optional) of occluded pixels is shown in FIGS. 5A, 5B, and 5C, respectively.

For the exemplary scene illustrated in FIG. 2, the 2D image obtained in FIG. 3A for visible pixels and the corresponding depth map obtained in FIG. 4A may be used to form the base layer of LDI, and the information of occluded pixels shown in FIGS. 5A, 5B, and 5C may be used to form the occlusion layer of LDI. Note that for this particular example, there is only one occlusion layer.

Generally depth pixels in occlusion layers are very sparse. Thus, rather than representing depth pixels using conventional 2D image formats, we can compress them into a dense signal. This can be done using existing methods, for example, using pixel linked list or Hash mapping. Using a pixel linked list as an example, we to can obtain a digital signal, L0, containing all the information of depth, color, alpha, X and Y coordinates of each depth pixel for the occlusion layers.

The likelihood that a pixel may be viewed from other view angles or used in multiple viewpoint video rendering varies. For example, pixels in the center of an image or in an ROI (region of interest) of an image may be viewed more often. On is the other hand, for pixels in different layers corresponding to an LDI pixel, the pixels closer to the viewer or the screen plane may be viewed more often. In addition, the smaller the distance between the occluded pixels and the occlusion boundary is, the more likely the pixel may be viewed. Moreover, the requirements of directors or other particular scenarios may also affect how often a pixel may be viewed from other angles.

Considering that some pixels may be viewed more often, we may embed information differently for different pixels. For example, we may embed the occluded pixels that are more likely to be viewed with stronger protection from transmission or compression errors. In one embodiment, weights are assigned to individual pixels and the information embedding is based on the weights. In one embodiment, more weights are assigned to depth pixels that may be viewed more often. The weights may be organized into a linear signal, W0. W0 and L0 may then be sorted according to the weights in W, generating two new signals of W1 and L1.

For example, LDI pixels A, B, and C in FIG. 1 can be expressed as follows:

L0=(A(pixel_{—}140),A(pixel_{—}150),B(pixel_{—}142),B(pixel_{—}152),B(pixel_{—}160), B(pixel_{—}170),C(pixel_{—}144),C(pixel_{—}154)). (1)

W0=(0.9,0.6,1.0,0.3,0.7,0.1,0.8,0.5). (2)

Sorting weights in W0 in a descending order, we obtain W1 as

W1=(1.0,0.9,0.8,0.7,0.6,0.5,0.3,0.1). (3)

Sorting L0 using the same sorting order for W1, we obtain L1 as

L1=(B(pixel_{—}142),A(pixel_{—}140),C(pixel_{—}144),B(pixel_{—}160),A(pixel_{—}150),C(pixel_{—}154),B(pixel_{—}152),B(pixel_{—}170)). (4)

The depth pixels in L1 may then be classified into different categories based on the weights. For example, depth pixels whose weights are greater than 0.6 may be grouped into one sub-set, and other depth pixels into another sub-set. That is,

sub-set 0:LL₀=(B(pixel_{—}142),A(pixel_{—}140),C(pixel_{—}144),B(pixel_{—}160)); (5)

sub-set 1:LL₁=(A(pixel_{—}150),C(pixel_{—}154),B(pixel_{—}152),B(pixel_{—}170)). (6)

Information in sub-sets 0 and 1 are now ready to be embedded into the 2D image or the depth map represented by a 2D+depth format. Digital watermarking is a process of embedding information into a digital signal which may be used to verify authenticity or identify of owners, in the same manner as document or photos bearing a watermark for visible identification. The main purpose of digital watermarking is to verify a watermarked content, while it could also be used to carry extra information without affecting the perceptual results for the original digital content. Least Significant Bit (LSB) is a digital image watermarking scheme that embeds watermarks in the least significant bit of the pixels. Spread spectrum watermarking (SSW) is a method similar to the spread spectrum communication that embeds watermark into a digital content as pseudo noise signals. LSB and SSW can carry relatively large amount of information and is quite robust to compression or transmission errors. Thus, in the following, watermarking based on LSB and SSW is used to illustrate the embedding process and the corresponding information extraction process.

For sub-sets 0 and 1 illustrated in Eqs. (5) and (6), sub-set 0 may be embedded with more protection than sub-set 1 as pixels in sub-set 0 may be viewed more often. For example, when spread spectrum is used for watermarking, a longer pseudo noise code (PN) may be used for sub-set 0, and a shorter PN code for sub-set 1. Specifically, two sub-sets of spread spectrum signals SS₀ and SS₁ are is generated:

SS₀=LL₀·PN₀,SS₁=LL₁·PN₁, (7)

wherein PN₀ is the longer PN code and PN₁ is the shorter one. When classifying the depth pixels, the watermarking data hiding capacity may also need to be considered such that the most important individual sub-sets may be well embedded. The watermarking data hiding capacity for a given system can be easily determined if certain parameters, such as the video resolution, watermarking technique to be used, and the transmission link quality, are known.

More generally, we assume that the depth pixels are grouped into n sub-sets. Then we can find a set of pseudo noise codes with different lengths and orthogonal to each other, such as Walsh codes used in a spread spectrum communication system. Longer PN codes are used to embed sub-sets of signal L1 with higher weights and shorter ones to sub-sets with lower weights when generating a set of spread spectrum signals [SS₀, SS₁, . . . , SSₙ]. The signals of SS₀, . . . , and SSₙ can then be combined to form a signal S0 using Code Division Multiple Access (CDMA) technique as follows:

S0=SS₀+SS₁+ . . . +SSₙ, (8)

After signal S0 is created, it can be added to or used to replace the least significant bit(s), such as the last 1 or 2 bits, of the depth and/or the 2D image to complete the digital watermarking process and create digital watermarked 2D image to and/or depth map. By repeating the process for each frame in a 3D video, the 3D video is now represented by a new 3D format. To keep the impact on the 2D image or the depth map small, the watermarks may be only embedded in certain areas of the 2D image or depth map.

The information embedding methods and associated parameters, for example, is pseudo noise codes, are needed at the receiver in order to recover the signal, and they can be embedded as metadata in the video stream or published as public ones.

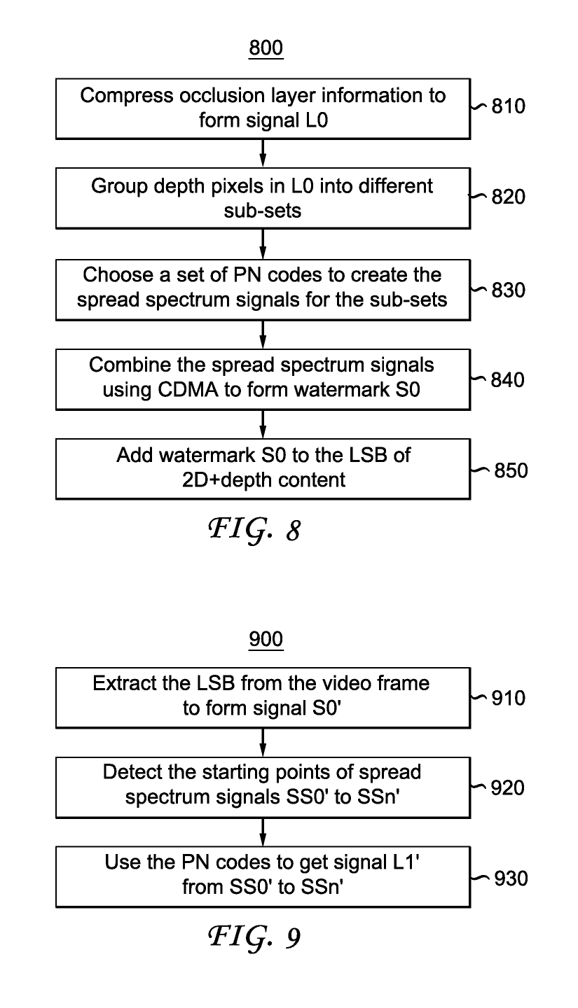

More generally, the exemplary process of embedding occlusion layer information is illustrated in method 800 as shown in FIG. 8. Method 800 can be used to perform step 650. In method 800, the occlusion layer information is compressed into a dense signal L0 at step 810, for example, as in Eq. (1). The depth pixels in L0 may then be grouped into different sub-sets at step 820, for example, using weights as illustrated in Eqs. (2)-(6). A set of pseudo noise codes are then used to create spread spectrum signal for the sub-sets at step 830, for example, as illustrated in Eq. (7). The spread spectrum signals for sub-sets may then be combined to form watermark at step 840, for example, as shown in Eq. (8). At step 850, the watermark can then be added to the least significant bit(s) of the 2D image and/or depth map represented by a 2D+depth format.

When a receiver is compatible with a 2D+depth format, but not with LDI format (such a receiver is also referred to as a conventional receiver) receives a 3D video in the new 3D video format, it can process the 3D video as if it is in a 2D+depth format, usually without perceptual impact to the content.

When a receiver compatible with the proposed new 3D format (such a receiver is also referred to as a new receiver) receives a 3D video in the new format, it can extract base layer and occlusion layers to recover the LDI format. An exemplary process 900 for extracting information to recover LDI is shown in FIG. 9, when watermarking based on LSB and SSW is used. Method 900 can be used to perform step 750. In method 900, pseudo noise codes are used to synchronize, detect, and recover signal L0 using CDMA techniques, for example using a convolutional receiver with multiple user detection, from signal S0. The recovered signal L0 can then be converted back to the disparity/depth, color, and alpha (optional) information for occlusion layers.

Specifically, at step 910, the least significant bits of video frames are extracted to form signal S0′ corresponding to signal S0. At step 920, the starting points of the spread spectrum signals (SS₀′ to SSₙ′) are detected. At step 930, using the detected spread spectrum signals (SS₀′ to SSₙ′), signal L1′ corresponding to L1 can be recovered using the pseudo noise codes. Specifically, signal LLₖ can be recovered by multiplying PNₖ with received signal S0′. When S0′=S0, LLₖ can be perfectly recovered. That is,

LLₖ′=S0·PNₖ=(Σᵢ₌₀ⁿLLᵢ·PNᵢ)·PNₖ, (9)

where LLₖ′ is the recovered signal corresponding to LLₖ. Note that for a set of orthogonal PN codes, PNₙ·PNₘ=0 (n≠m), and PNₙ·PNₙ/|PNₙ|²=1. Combining LLₖ′, k=1, n, signal L1′ corresponding to L1 can be reconstructed at step 930. Consequently, occlusion layer information can be obtained.

By combining the occlusion layers and base layer, we can then restore the full LDI. Then, new camera viewpoints can be rendered using image-based rendering methods based on LDI, and the 3D video can be presented without occlusions at the receiver.

By performing the watermarking embedding process for signal L1′ at the receiver, another CDMA signal S0″ can be obtained, which may be a better reproduction of signal S0 than S0′. Subsequently, the watermark can be removed by subtracting signal S0″ from the received content. This step can be skipped if the watermark has no perceptual impact on the content or the receiver has limited processing power.

The watermarking data hiding capacity is a function of the watermarking method and the original image. The 2D image and the depth map, which can be represented by 2D+depth format, are usually rather sparse and have little high frequency signal. Thus, it is possible to use more than one LSB bit or more spectrum in high frequency band to carry the watermark. Therefore, we expect the watermark has sufficiently large data hiding capacity to embed the occlusion layer information.

If the occlusion layers have more information than the data hiding capacity provided by watermarking, we may choose not to embed all occlusion layer information. For example, some depth pixels that are less likely to be viewed may not be embedded. How much information is to be embedded will depend on the watermarking capacity, the content, the receiver, and the range of possible viewing angle.

Alternatively, to increase the data hiding capacity, we may use a higher bit depth for the 2D image or depth map, for example, extend the depth map from 8 bits grayscale to 24 bits or more.

In other embodiments, other data hiding methods, such as other watermarking techniques including discrete cosine transform (DCT) or discrete wavelet transform (DWT) can be used to embed occlusion layer information.

In the above, we have discussed how information contained in an LDI can be represented by a new 3D video format that is backward compatible with 2D+depth format. The methods can also be extended to represent information contained in other formats, for example, in a 2D+DOT format. 2D+DOT format, an extension to 2D+depth map representation, provides additional occlusion and transparency information and allows the display of higher quality 3D video. Similarly to what has been discussed for LDI, we may embed the additional occlusion and transparency information into the 2D image and/or the depth map. The present principles can be extended to other formats in addition to LDI and 2D+DOT.

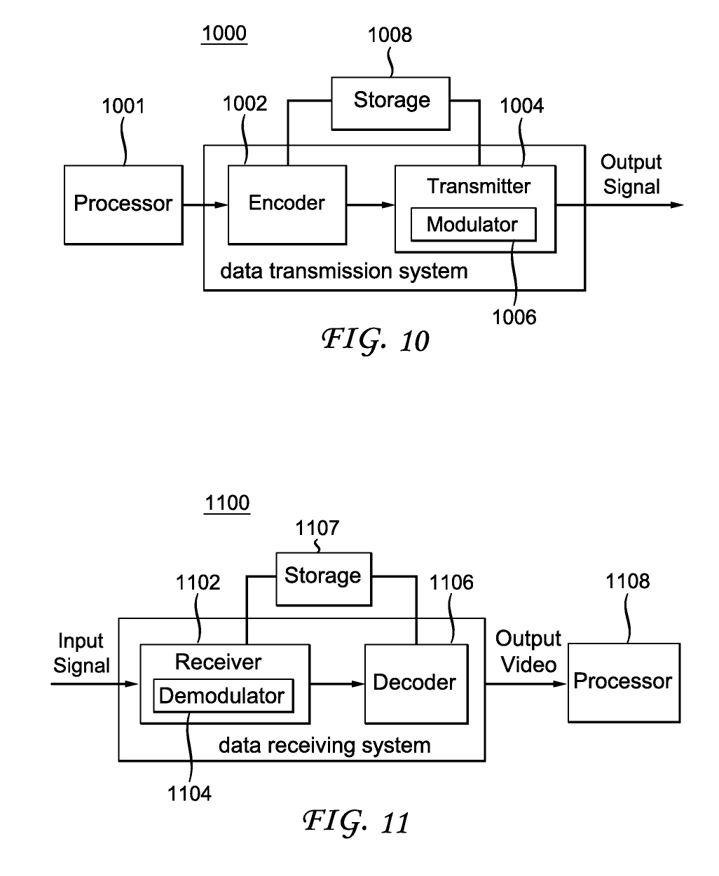

Referring now to FIG. 10, a video transmission system or apparatus 1000 is shown, to which the features and principles described above may be applied. The video transmission system or apparatus 1000 may be, for example, a head-end or transmission system for transmitting a signal using any of a variety of media, such as, for example, satellite, cable, telephone-line, or terrestrial broadcast. The video transmission system or apparatus 1000 also, or alternatively, may be used, for example, to provide a signal for storage. The transmission may be provided over the Internet or some other network. The video transmission system or apparatus 1000 is capable of generating and delivering, for example, video content and other content such as, for example, 3D video data including occlusion layer information. It should also be clear that the blocks of FIG. 10 provide a flow diagram of a video transmission process, in addition to providing a block diagram of a video transmission system or apparatus.

The video transmission system or apparatus 1000 receives input 3D video data from a processor 1001. In one implementation, the processor 1101 represents to the 3D video data (input in LDI format) in the new 3D format according to the methods described in FIGS. 6 and 8 or other variations. The processor 1001 may also provide metadata to the video transmission system or apparatus 1000 indicating, for example, the resolution of an input image, the information embedding method, and the metadata associated with the embedding method.

The video transmission system or apparatus 1000 includes an encoder 1002 and a transmitter 1004 capable of transmitting the encoded signal. The encoder 1002 receives video information from the processor 1001. The video information may include, for example, video images, and/or disparity (or depth) images. The encoder 1002 generates an encoded signal(s) based on the video and/or depth information. The encoder 1002 may be, for example, an H.264/AVC encoder. The H.264/AVC encoder may be applied to both video and depth information. When both the video and the depth map are encoded, they may use the same encoder under the same or different encoding configurations, or they may use different encoders, for example, and H.264/AVC encoder for the video and a lossless data compressor for the depth map.

The encoder 1002 may include sub-modules, including for example an assembly unit for receiving and assembling various pieces of information into a structured format for storage or transmission. The various pieces of information may include, for example, coded or uncoded video, coded or uncoded disparity (or depth) values, and syntax elements. In some implementations, the encoder 1002 includes the processor 1001 and therefore performs the operations of the processor 1001.

The transmitter 1004 receives the encoded signal(s) from the encoder 1002 to and transmits the encoded signal(s) in one or more output signals. The transmitter 1004 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the is signal, and modulating the signal onto one or more carriers using a modulator 1006. The transmitter 1004 may include, or interface with, an antenna (not shown). Further, implementations of the transmitter 1004 may be limited to the modulator 1006.

The video transmission system or apparatus 1000 is also communicatively coupled to a storage unit 1008. In one implementation, the storage unit 1008 is coupled to the encoder 1002, and stores an encoded bitstream from the encoder 1002. In another implementation, the storage unit 1008 is coupled to the transmitter 1004, and stores a bitstream from the transmitter 1004. The bitstream from the transmitter 1004 may include, for example, one or more encoded bitstreams that have been further processed by the transmitter 1004. The storage unit 1008 is, in different implementations, one or more of a standard DVD, a Blu-Ray disc, a hard drive, or some other storage device.

Referring now to FIG. 11, a video receiving system or apparatus 1100 is shown to which the features and principles described above may be applied. The video receiving system or apparatus 1100 may be configured to receive signals over a variety of media, such as, for example, storage device, satellite, cable, telephone-line, or terrestrial broadcast. The signals may be received over the Internet or some other network. It should also be clear that the blocks of FIG. 11 provide a flow diagram of a video receiving process, in addition to providing a block diagram of a video receiving system or apparatus.

The video receiving system or apparatus 1100 may be, for example, a cell-phone, a computer, a set-top box, a television, or other device that receives encoded video and provides, for example, decoded video signal for display (display to a user, for example), for processing, or for storage. Thus, the video receiving system or apparatus 1100 may provide its output to, for example, a screen of a television, a computer monitor, a computer (for storage, processing, or display), or some other storage, processing, or display device.

The video receiving system or apparatus 1100 is capable of receiving and processing video information, and the video information may include, for example, video images, and/or disparity (or depth) images. The video receiving system or apparatus 1100 includes a receiver 1102 for receiving an encoded signal. The receiver 1102 may receive, for example, a signal providing one or more of a 3D video represented by 2D+depth format, or a signal output from the video transmission system 1000 of FIG. 10.

The receiver 1102 may be, for example, adapted to receive a program signal having a plurality of bitstreams representing encoded pictures. Typical receivers perform functions such as, for example, one or more of receiving a modulated and encoded data signal, demodulating the data signal from one or more carriers using a demodulator 1104, de-randomizing the energy in the signal, de-interleaving the data in the signal, and error-correction decoding the signal. The receiver 1102 may include, or interface with, an antenna (not shown). Implementations of the receiver 1102 may be limited to the demodulator 1104.

The video receiving system or apparatus 1100 includes a decoder 1106. The to receiver 1102 provides a received signal to the decoder 1106. The signal provided to the decoder 1106 by the receiver 1102 may include one or more encoded bitstreams. The decoder 1106 outputs a decoded signal, such as, for example, decoded video signals including video information. The decoder 1106 may be, for example, an H.264/AVC decoder.

The video receiving system or apparatus 1100 is also communicatively coupled to a storage unit 1107. In one implementation, the storage unit 1107 is coupled to the receiver 1102, and the receiver 1102 accesses a bitstream from the storage unit 1107. In another implementation, the storage unit 1107 is coupled to the decoder 1106, and the decoder 1106 accesses a bitstream from the storage unit 1107. The bitstream accessed from the storage unit 1107 includes, in different implementations, one or more encoded bitstreams. The storage unit 1107 is, in different implementations, one or more of a standard DVD, a Blu-Ray disc, a hard drive, or some other storage device.

The output video from the decoder 1106 is provided, in one implementation, to a processor 1108. The processor 1108 is, in one implementation, a processor configured for recovering LDI from 3D video data represented by 2D+depth format, for example, according to the methods described in FIGS. 7 and 9 and other variations. In some implementations, the decoder 1106 includes the processor 1108 and therefore performs the operations of the processor 1108. In other implementations, the processor 1108 is part of a downstream device such as, for example, a set-top box or a television.

The implementations described herein may be implemented in, for example, a to method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces to of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating is the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for processing data representative of a 3D video image, comprising the steps of:
accessing the data representative of the 3D video image;
determining information associated with occluded pixels of the 3D video image;
grouping the occluded pixels into a plurality of sets; and
embedding the information associated with the occluded pixels into data associated with visible pixels in response to the grouping.

2. The method of claim 1, wherein the 3D video image is represented by a first format including one of layered depth image (LDI) or 2D+DOT.

3. The method of claim 1, further comprising the step of:
representing the data associated with the visible pixels by one of a 2D+depth format and 2D+delta format.

4. The method of claim 1, wherein the grouping step is performed in response to likelihood that an occluded pixel may become a visible pixel when the 3D video image is viewed from other view angles or likelihood that the occluded pixel may be used in multiple viewpoint video rendering.

5. The method of claim 4, wherein the embedding is performed such that stronger protections are provided for the occluded pixels that are more likely to become the visible pixels when the 3D video image is viewed from the other view angles or more likely to be used in the multiple viewpoint video rendering.

6. The method of claim 1, wherein the grouping step is in response to at least one of the following, for an occluded pixel of the 3D video image:
a. where the occluded pixel is located,
b. a distance between the occluded pixel and at least one of a viewer and a screen plane,
c. a distance between the occluded pixel and a corresponding occlusion boundary, and
d. requirements of directors.

7. The method of claim 1, wherein the embedding step uses watermarking.

8. The method of claim 7, wherein a spread spectrum signal is generated in response to each set of the plurality of sets, and wherein a sum of the spread spectrum signals are embedded in the data associated with the visible pixels using Least Significant Bit (LSB) watermarking.

9. A method for processing data representative of a 3D video image, comprising the steps of:
accessing the data containing information associated with visible pixels of the 3D video image, wherein occlusion layer information for a plurality of groups of occluded pixels of the 3D video image is embedded in the information associated with the visible pixels;
determining a respective embedding method for each one of the plurality of groups of the occluded pixels; and
extracting the occlusion layer information for the plurality of groups of the occluded pixels in response to the respective embedding methods.

10. The method of claim 9, wherein the information associated with the visible pixels and the occlusion layer information for the plurality of groups of the occluded pixels are used to represent the 3D video image in one of LDI and 2D+DOT formats.

11. The method of claim 9, wherein the information associated with the visible pixels is represented by one of 2D+depth and 2D+delta formats.

12. The method of claim 9, wherein the respective embedding method uses watermarking.

13. The method of claim 12, wherein a different pseudo noise code is used to reconstruct the each one of the plurality of groups of the occluded pixels from a spread spectrum signal.

14. An apparatus for processing data representative of a 3D video image, comprising a processor configured to:
access the data representative of the 3D video image,
determine information associated with occluded pixels of the 3D video image,
group the occluded pixels into a plurality of sets, and
embed the information associated with the occluded pixels into data associated with visible pixels in response to the grouping.

15. The apparatus of claim 14, wherein the 3D video image is represented by a first format including one of layered depth image (LDI) or 2D+DOT.

16. The apparatus of claim 14, wherein the processor represents the data associated with the visible pixels by one of a 2D+depth format and 2D+delta format.

17. The apparatus of claim 14, wherein the processor is configured to group the occluded pixels responsive to likelihood that an occluded pixel may become a visible pixel when the 3D video image is viewed from other view angles or likelihood that the occluded pixel may be used in multiple viewpoint video rendering.

18. The apparatus of claim 17, wherein the processor is configured to embed the information associated with the occluded pixels such that stronger protections are provided for the occluded pixels that are more likely to become the visible pixels when the 3D video image is viewed from the other view angles or more likely to be used in the multiple viewpoint video rendering.

19. The apparatus of claim 14, wherein the processor is configured to group the occluded pixels responsive to at least one of the following, for an occluded pixel of the 3D video image:
a. where the occluded pixel is located,
b. a distance between the occluded pixel and at least one of a viewer and a screen plane,
c. a distance between the occluded pixel and a corresponding occlusion boundary, and
d. requirements of directors.

20. The apparatus of claim 14, wherein the processor is configured to use watermarking for embedding.

21. The apparatus of claim 20, wherein the processor is configured to generate a spread spectrum signal responsive to each set of the plurality of sets, and wherein the processor is configured to embed a sum of the spread spectrum signals in the data associated with the visible pixels using Least Significant Bit (LSB) watermarking.

22. An apparatus for processing data representative of a 3D video image, comprising a processor configured to:
access the data containing information associated with visible pixels of the 3D video image, wherein occlusion layer information for a plurality of groups of occluded pixels of the 3D video image is embedded in the information associated with the visible pixels,
determine a respective embedding method for each one of the plurality of groups of the occluded pixels, and
extract the occlusion layer information for the plurality of groups of the occluded pixels in response to the respective embedding methods.

23. The apparatus of claim 22, wherein the information associated with the visible pixels and the occlusion layer information for the plurality of groups of the occluded pixels are used to represent the 3D video image in one of LDI and 2D+DOT formats.

24. The apparatus of claim 22, wherein the processor is configured to represent the information associated with the visible pixels by one of 2D+depth and 2D+delta formats.

25. The apparatus of claim 22, wherein the respective embedding method is configured to use watermarking.

26. The apparatus of claim 25, wherein the processor is configured to use a different pseudo noise code to reconstruct the each one of the plurality of groups of the occluded pixels from a spread spectrum signal.

27. (canceled)
